(19) United States
(12) Patent Application Publication
(10) Pub. No.: US 2024/0278246 A1
(43) Pub. Date: Aug. 22, 2024

(54) Blister Opening System Comprising a Blister and an Actuation Pusher

(71) Applicant: Creganna Unlimited Company, Ballybrit, Galway (IE)

(72) Inventors: Luis FERNANDEZ LEDESMA, Guipuzcoa (ES); Andreu LLOBERA ADAN, Guipuzcoa (ES); Irene VARELA LENIZ, Guipuzcoa (ES); Pablo GARCÍA DE MADINABEITIA MERINO, Guipuzcoa (ES)

(73) Assignee: Creganna Unlimited Company, Ballybrit, Galway (IE)

(21) Appl. No.: 18/681,121

(22) PCT Filed: Jul. 28, 2022
(86) PCT No.: PCT/EP2022/071169

§ 371 Date: Feb. 5, 2024

(30) Foreign Application Priority Data
Aug. 6, 2021 (EP) 21382743.9

(51) Int. Cl. B01L 3/00

(52) U.S. Cl. CPC B01L 3/523; B01L 3/502715; B01L 2200/027; B01L 2200/16; B01L 2300/0672; B01L 2400/0478; B01L 2400/0481

(57) ABSTRACT

This invention relates to a blister opening system comprising a blister body (1) arranged over a support surface (1′″); a header (2) comprising an impelling surface (2′), wherein said header (2) is movable relative to the blister body (1) and transmits a pressure against the blister body (1) through the impelling surface (2′) in a pushing direction (3); and a fluidic outlet channel (4) fluidically connected to the blister body (1). The system is characterized in that the impelling surface (2′) is arranged such that, in a relative position between the header (2) and the blister body (1) the pushing direction (3) and the support surface (1′″) form a relative angle (5) substantially different from 90°. The pressure of the impelling surface (2′) against the blister body (1) configures a gas entrapment volume (1″) at an opposite side of the blister body (1) with regard to the fluidic outlet channel (4).

### FIELD OF THE INVENTION

The present invention belongs to the technical field of microfluidics. More specifically, the invention relates to a blister opening system comprising an actuation pusher and a blister used for storing and releasing fluidic reagents in a microfluidic circuit. The blister opening system is advantageously adapted to avoid air-bubble injection in said circuit when releasing the reagents.

### BACKGROUND OF THE INVENTION

Most of the known reagent-storing blisters used in microfluidic applications exhibit a dome-shaped body. In order to open those blisters and release their reagents, cylindrical pushers are vertically arranged over the blisters and operated so as to exert pressure on their surface, effectively reducing their volume and forcing the reagents to flow out into a microfluidic circuit. As an example of these blisters and pushers, U.S. Pat. No. 9,610,579 B2 discloses several embodiments of a microfluidic blister comprising a plastically deformable reservoir, which is operated through a cylindrical pusher comprising a dome-shaped header adapted with an impelling surface. An example of said type of header is illustrated in FIG. 1 of the present application.

However, these known dome-shaped headers are prone to inject a significant amount of air bubbles when they are applied to release the content of the blister. This is mainly due to the fact that blisters always have a fraction of their internal volume filled with air. As the pusher progressively deforms the top surface of the dome, this air is displaced down and towards the edges of the blister. As a solution for avoiding the passage of bubbles into the microfluidic circuit, a rib surrounding the top surface of the dome-shaped blister ensures its controlled folding, with the aim to entrap the air in the structure thereby defined. Yet, if the deformation is too high, this structure also collapses, resulting in a non-desirable air injection into the microfluidic circuit.

Other prior-art alternatives disclose blister pushers advantageously adapted to avoid air injection and, at the same time, not harming the operativity of the blister (in terms of storage volume, capability of providing a leak-tight seal, so that the reagents flow in a certain direction, etc.). For instance, U.S. Pat. No. 8,083,716 B2 discloses a plunger head within a fluid reservoir, which is shaped so as to limit the presence of air bubbles in a fluidic medium expelled from the reservoir. With this purpose, the plunger head is shaped with a concave region, thereby forming a bubble-trapping region. However, these pushers have the problem that some of the formed bubbles may still escape from the trap and flow into the microfluidic circuit.

Other alternatives for venting air bubbles in microfluidic systems comprise the use of permeable membranes (see for example U.S. Pat. No. 9,962,698 B2 and Liu et al., “A membrane based, high-efficiency, microfluidic debubbler”, Lab on a Crip, 11(9), 1688-1693 (2011)). These pushers also present the drawback of injecting a small amount of gas bubbles into the microfluidic circuit when the blister releases the liquid reagents. They are also more complex than other alternatives, and less suitable for mass-scale production.

The present invention proposes a solution to the technical problems mentioned above, by means of a blister opening system comprising a novel pusher and blister design that avoids the injection of gas bubbles without the need of venting membranes or other equivalent means.

### BRIEF DESCRIPTION OF THE INVENTION

A first object of the present invention relates to a blister opening system, comprising:
A blister body arranged over a support surface, wherein said blister body is collapsible under pressure and adapted for storing a liquid volume.
A header comprising an impelling surface, wherein said header is adapted for being movable relative to the blister body and to transmit, with said relative movement, a pressure against the blister body through the impelling surface in a pushing direction.
A fluidic outlet channel fluidically connected to the blister body and adapted such that the liquid volume can flow from the blister body towards said fluidic outlet channel when pressure is exerted against the blister body by the header.

Advantageously in the invention, the impelling surface of the header is adapted such that, in at least a relative position between the header and the blister body:
The pushing direction and the support surface form a relative angle substantially different from 90°.
The pressure of the impelling surface against the blister body configures a gas entrapment volume in the blister body, wherein said gas entrapment volume is arranged substantially at an opposite side of the blister body with regard to the fluidic outlet channel.

In a preferred embodiment of the invention, the impelling surface of the header is adapted to press the blister body to dispense at least the 80% of the liquid volume stored within said blister body through the fluidic outlet channel.

In a preferred embodiment of the invention, the impelling surface of the header is substantially tilted relative to the support surface at the complementary angle of the relative angle defined by the pushing direction and the support surface.

In alternative embodiments of the invention, the impelling surface of the header is substantially parallel to the support surface. More preferably, in those embodiments, the blister body comprises a blister surface adapted to contact the impelling surface, said blister contact surface being substantially tilted relative to the support surface at the complementary angle of the relative angle defined by the pushing direction and the support surface.

In further preferred embodiments of the invention, the header of the blister opening system comprises a plunger or a pusher, which is actuated by actuation means.

In further preferred embodiments of the invention, the header comprises a notch, a protrusion or an indentation arranged adjacent to the fluidic outlet channel, thereby providing means for minimizing the backflow. More preferably, the impelling surface of the header comprises one or more indentations and/or recesses.

In further preferred embodiments of the invention, the impelling surface of the header is flat. In such embodiments, the blister body is preferably arranged over a support surface, said support surface defining an angle substantially different from 0° relative to the impelling surface of the header. Said angle, which is the complementary of the relative angle defined by the pushing direction and the support surface, provides a means for advantageously defining the gas entrapment volume.

In a preferred embodiment of the invention, a portion of the header (e.g., the notch) is adapted to be switchable, at least, between two positions wherein, in a first position, the impelling surface occludes the fluidic outlet channel, and in a second position, the impelling surface opens the outlet channel, so as to selectively regulate the liquid volume dispensed into a microfluidic circuit through said channel.

In more preferred embodiments of the invention, the blister opening system further comprises a holder adapted with a cavity (blister seat) for placing the blister body, and actuation means comprising:
A mechanical arrangement, comprising a piston connected to a snail cam comprising a pass-through orifice. The orifice of the snail cam is crossed by said rotating camshaft.
A stepper motor actuating over the camshaft to induce the camshaft rotation, which leads to the displacement of the piston. In this way, the piston transmits pressure to the header depending on the direction, angle, and speed of camshaft rotation.

In more preferred embodiments of the invention, the blister opening system further comprises a switch configured to stop the rotation of the camshaft, in one of the following cases:
if the piston reaches a predetermined maximum shift or position; or
if the header contacts the blister body.

In more preferred embodiments of the invention, the holder of the blister opening system further comprises a blister metering device, fluidically connected to the fluid outlet channel, said blister metering device being adapted to measure the liquid volume and gas dispensed through the fluidic outlet channel.

Within the scope of the invention, the expression “substantially different from 0°” will be understood as at least 10°. Moreover, the expression “substantially equal to 0°” or “substantially parallel” will be understood as below 5°. By the way, the expression “substantially different from 90°” will be understood as a deviation of at least ±10° with regard to 90°.

Finally, the expression “pushing direction” is defined as a direction orthogonal to a plane defined by the header and the blister body when said header exerts pressure over the blister body.

### DESCRIPTION OF THE FIGURES

FIG. 1 shows a prior-art dome-shaped pusher commonly used for actuating blisters in microfluidic applications.

FIG. 2A-2C show, respectively, the top (a), front (b) and right-side (c) views of a preferred embodiment of a pusher according to the invention.

FIGS. 3A-3D show a schematic representation of the blister's liquid release when using the pusher of FIGS. 2A-2C.

FIGS. 4A-4D show different pusher geometries proposed according to the invention.

FIGS. 5A-5B correspond to an experimental setup for testing (actuating) a blister for releasing a liquid reagent, according to a preferred embodiment of the invention.

FIG. 6 illustrates a schematic representation of a blister metering device according to the invention. More specifically, FIG. 6A represents the channels and chambers of the blister metering device. FIG. 6B corresponds to a zoom view of two chambers closest to the blister seat contained within the dashed line box of FIG. 6A.

FIG. 7 shows the volume of dispensed liquid (μl) and air (mm³) as a function of the camshaft rotation speed (rpm) for two different blister volumes: A) 50 μl and B) 100 μl. The camshaft rotation angle was of 360° (a maximum displacement of 5 mm according to the experimental setup of FIG. 6).

FIG. 8 illustrates the volume of dispensed liquid (μl) and air (mm³) as a function of the pusher design for 200 μl blisters. In that case, the camshaft rotation speed is set to 15 rpm and the rotation angle is 270° (3.75 mm piston displacement).

FIG. 9 summarizes the liquid and air volume dispensed with different pusher geometries (P02-P05) according to the invention, compared to a prior-art pusher (P01).

### NUMERICAL REFERENCES USED IN THE DRAWINGS

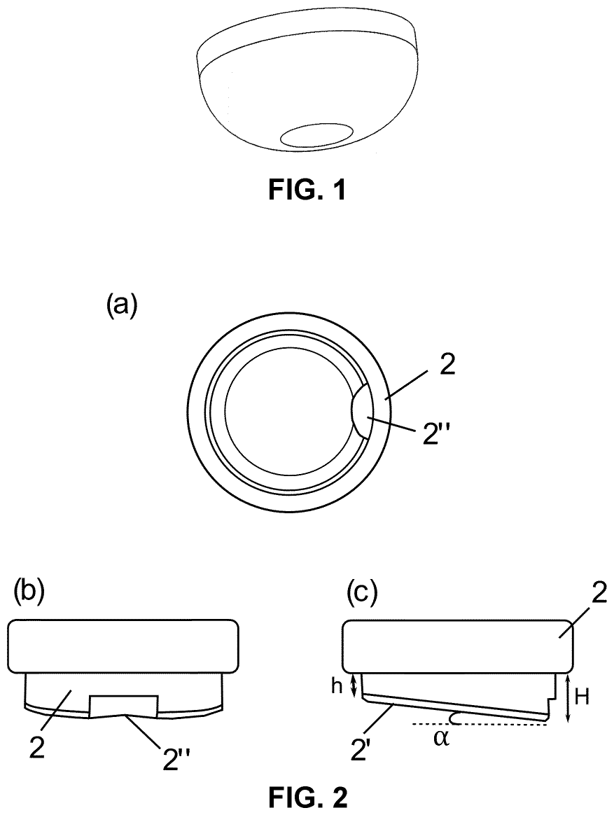

In order to provide a better understanding of the technical features of the invention, the referred FIGS. 1-9 are accompanied of a series of numerical references which, with an illustrative and non-limiting character, are hereby represented:

| | |
|---|---|
| 1 | Blister body |
| 1′ | Liquid volume |
| 1″ | Gas entrapment volume |
| 1″′ | Support surface |
| 2 | Header (e.g., a plunger or a pusher) |
| 2′ | Impelling surface of the header |
| 2″ | Notch |
| 3 | Pushing direction |
| 4 | Fluidic outlet channel |
| 5 | Angle between the impelling surface and |
| | the blister surface (second angle) |
| 6 | Surface of the blister body |
| 7 | Actuation means |
| 7′ | Piston |
| 7″ | Snail cam |
| 7″′ | Camshaft |
| 8 | Holder |
| 9 | Blister metering device |
| 9′ | Cavities of the blister metering device |
| 9″ | Channels of the blister metering device |
| 9″′ | Blister seat |

### DETAILED DESCRIPTION OF THE INVENTION

As described in the preceding paragraphs, the present invention relates to a blister opening system for dispensing the content of a blister body (1) into a microfluidic circuit, without injecting gas bubbles thereinto. Said blister opening system comprises:
A blister body (1), which is collapsible under pressure, adapted for storing a liquid volume (1′), typically comprising one or more reagents.
A header (2) comprising an impelling surface (2′) adapted to transmit pressure against the blister body (1). This header (2) can move relative to the blister body (1) in order to transmit, with said relative movement, a pressure against the blister body (1) through the impelling surface (2′) in a pushing direction (3). Said pushing direction (3) is orthogonal to a plane defined by the header (2) and the blister body (1) when said header (2) exerts pressure over the blister body (1).
A fluidic outlet channel (4) fluidically connected to the blister body (1), so that the liquid volume (1′) can be dispensed from the blister body (1) towards said fluidic outlet channel (4) when pressure is exerted against the blister body (1).

Advantageously in the invention, the pushing direction (3) and the support surface (1′″) form a relative angle (5) substantially different from 90°. This relative angle (5) is defined by the pushing direction (3) and the support surface (1′″). Moreover, the pressure of the impelling surface (2′) against the blister body (1) configures a gas entrapment volume (1″) in the blister body (1). Said gas entrapment volume (1″) is arranged substantially at an opposite side of the blister body (1) with regard to the fluidic outlet channel (4).

The aim of this blister opening system is maximizing the volume of liquid that can be dispensed out of the storage blister body (1) into a microfluidic circuit without injecting gas bubbles thereinto.

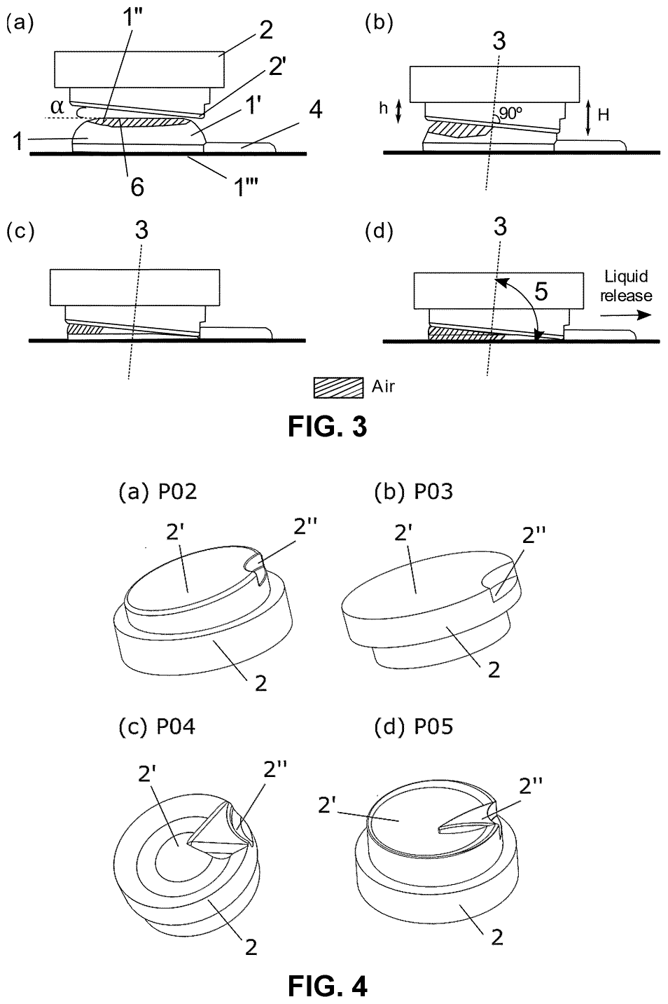

FIGS. 2A-2C show a pusher according to a preferred embodiment of the invention, referred to as pusher P02, arranged over a support surface (1′″). The support surface (1′″) is not necessary flat. More particularly in these figures, different top (a), front (b) and side (c) views of the pusher are displayed. Preferably in the invention, an impelling surface (2′) of the header (2) is tilted a certain angle α with regard to the support surface (1′″). Said angle α is the complementary of the relative angle (5) defined by the pushing direction (3) and the support surface (1′″). Thanks to the optimization of the relative angle (5) value, the header (2) can minimize the release of gas bubbles, as further explained in FIG. 3. In this embodiment, the header (2) comprises a notch (2″).

The working mechanism of pusher P02 for actuating a blister body (1) is sequentially illustrated in FIGS. 3A-3D, according to a preferred embodiment of the invention. Under this embodiment, the impelling surface (2′) of the header (2) defines an angle α with respect to the support surface (1′″), which enables the liquid contained inside the blister body (1) to be released into a microfluidic circuit through the fluidic outlet channel (4), as the header (2) crushes or contacts a surface (6) of the blister body (1). FIG. 3A corresponds to the initial case wherein the header (2) is approaching the blister body (1). FIGS. 3B-3C show how, once the impelling surface (2′) of the header (2) contacts the surface (6) of the blister body, it displaces the air volume inside the blister body (1) away from the fluidic outlet channel (4), thereby avoiding the injection of air bubbles into the fluidic outlet channel (4). Maximum liquid volume (1′) dispensing occurs when the header (2) contacts the base of the blister body (1) in the fluidic outlet channel, as shown in FIG. 3D. Under this embodiment, the header (2) is shaped with a maximum height (H) in the side which blocks the fluidic outlet channel (4), whereas the height (h) in the opposite direction is smaller. At this point (see FIG. 3D), the air bubbles are blocked within the blister body (1) in a gas entrapment volume (1′) and, as a result, no transference of gas bubbles takes place through the fluidic outlet channel (4).

In the preferred embodiments of the invention illustrated in FIGS. 2-3, the relative angle (5) is achieved by adapting the header (2) with a tilted impelling surface (2′) with regard to the support surface (1′″). Alternatively, it is also possible to design a tilted blister surface (6), while the impelling surface (2′) of the header (2) is flat (parallel to the support surface (1′″)). Therefore, the existence of a relative angle (5) between the pushing direction (3) and the support surface (1′″) or, equivalently, an angle substantially different from 0° defined between the impelling surface (2′) of the header (2) and the main surface of the blister body (1) (either the support surface (1′″) or the tilted blister surface (6)), enables the gas entrapment volume (1′) within the blister body (1).

Further embodiments of the header (2) according to the invention are illustrated in FIG. 4, where the P02 pusher is compared with alternative pusher geometries, referred to as P03, P04, P05. For instance, pusher P03 exhibits a flat impelling surface (2′), but in this case the blister surface (6) is tilted with respect to the header (2).

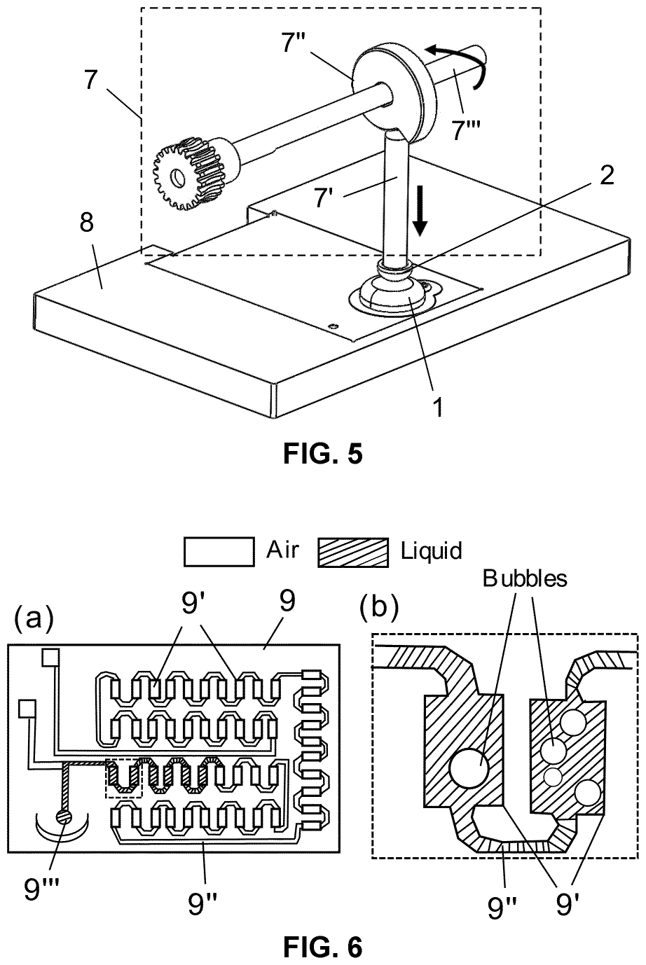

For validating the advantages of the present invention, a comparison of the different pusher geometries (P02-P05) shown FIGS. 2-4 with the geometry of FIG. 1 (referred to as P01) has been performed. For this purpose, the maximum volume of liquid dispensed via the fluidic outlet channel (4), before air bubbles are injected, has been measured. For each pusher geometry, the volume of air has also been measured. The smaller the air volume, the better the pusher performance. For this test, the mechanical setup shown in FIG. 5 has been applied for blister actuation, by using actuation means (7). Said actuation means (7) comprise, preferably:
A mechanical arrangement, comprising a piston (7′) and a perforated snail cam (7″) connected to a rotating camshaft (7′″). The snail cam (7″) comprises a pass-through orifice, and said orifice is crossed by said rotating camshaft (7′″).
A stepper motor actuating over the camshaft (7″″) for inducing its rotation, thereby leading to the displacement of the piston (7′). The piston (7′) transmits pressure to the header (2) depending on the direction, angle, and speed of camshaft (7′″) rotation. The camshaft (7′″) rotates an angle equivalent to a specific number of steps given by the motor. A motor controller allows setting the desired rotation speed of the camshaft (7′″), as well as the direction of rotation. As the camshaft (7′″) rotates, so does the snail cam (7″) located at that axis. Thereby, the piston (7′) moves down in a controlled way towards the blister body (1). Preferably, if the piston (7′) reaches the maximum displacement value, a limit switch is triggered, and the rotation of the camshaft (7′″) stops.

FIG. 5 also illustrates a blister holder (8) or support that contains the blister body (1).

In order to study the optimal design of the five pushers P02-P05 presented in FIGS. 2-4, it is necessary to define the optimal conditions concerning the rotation speed and angle of the header (2) (from now on, also referred to as the pusher) for exerting pressure over the blister body (1), as these two variables are related to the displacement of the pusher on the blister (1). The conditions related to pusher performance was studied in 50 μl and 100 μl blister bodies (1). Different speeds were tested inside the operational range of the setup for blister actuation, rising from 3 revolutions per minute (rpm) to 21 rpm. Pusher P01 (FIG. 1) is used for standardization and the angle of rotation of the camshaft (7′″) was defined as 360° (maximum piston displacement, 5 mm).

FIGS. 6A-6B show a schematic representation of a blister metering device (9) after testing a P01 blister (FIG. 1) with the experimental setup of FIG. 5. A blister metering device (9), working as a microfluidic circuit, is used to quantify the fluidic release and air volume injection as a function of the camshaft (7′″) rotation speed, as it will be later detailed. For instance, the blister metering device (9) can be arranged at the blister holder (8). During the liquid release tests, microscopy images were acquired, enabling further quantification of the filled cavities (9′) or chambers and channels (9″) of the blister metering device (9), via image analysis. In this way, the blister body (1) is placed at a cavity or blister seat (9′″) and pressure is exerted over said blister body (1) with the mechanical arrangement in FIG. 5. Then, by fluidically connecting the fluidic outlet channel (4) with the blister meter device (9), it is possible to measure the amount of liquid and bubbles dispensed through the fluidic output channel (4) during blister's body (1) collapse. For visualization purposes, the blisters can be filled with dyed water, so that the dispensed liquid is easier to observe in microscope images of the cavities (9′) and channels (9″) of the blister metering device (9). Note that, in the case illustrated in FIG. 6B, most of the air volume is dispensed at the end of the assay, as bubbles are detected at the chambers closest to the blister seat (9′″). In this way, it is proven that a complete collapse of the blister aiming to release the highest amount of liquid is detrimental in terms of operativity, as air bubbles are also injected to the microfluidic circuit through the fluidic outlet channel (4).

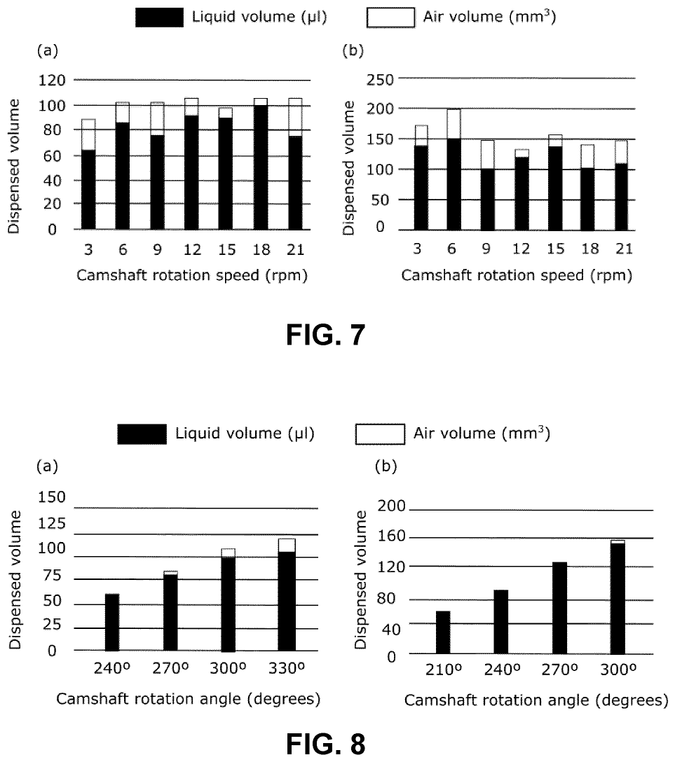

Quantification of the dispensed liquid and air volume as a function of the camshaft rotation speed is shown in FIGS. 7A and 7B for 50 μl and 100 μl, respectively. In both cases, the minimum air injected into the microfluidic channels is obtained when the camshaft rotation speed varies between 12 rpm and 18 rpm.

Also, it is also important to study the dispensed liquid and air volumes as a function of the pusher displacement, which is controlled by the rotation angle of the camshaft (7′″) (as explained in FIG. 5). Rotation angles between 210° and 330° are studied for 100 μl (FIG. 8A) and 200 μl (FIG. 8B) blister. The camshaft rotation speed is set to 15 rpm, considering the test of FIG. 7. As the volume of the blister increases, so does the height of the blister body. If the initial distance between the blister and pusher is kept constant, then as the blister volume increases, the camshaft (7′″) rotation angle must be smaller to achieve the same displacement. Thus, the range of angles selected for each blister volume has been slightly modified.

From the results obtained, it is possible to determine the maximum pusher displacement (given by the camshaft (7′″) rotation angle) to avoid air injection into a microfluidic circuit for blister volumes 100 μl and 200 μl. This displacement corresponds to 3.3 mm (at 240°) and 3.75 mm (at 270°) respectively. Similarly, it was shown that, once the camshaft (7′″) rotates to the fixed angle (meaning a pusher displacement), it is preferable to keep the pusher in the lower position until the end of the protocol. If the header (2) (the pusher) pressure is released, the blister body (1) structure minimally recovers its original shape due to the elastic nature of the material that composes it. This may cause a small undesirable backflow towards the blister body (1).

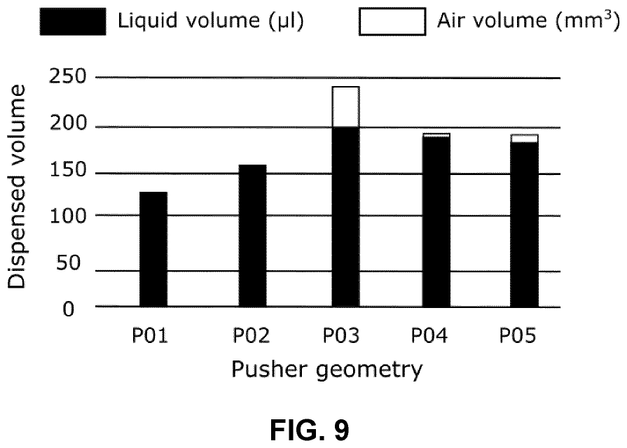

Once the optimum conditions (angle and rotation speed) for pusher operativity have been obtained for the P01 pusher, as shown in FIGS. 7-8, the remaining pusher geometries P02-P05 are tested in the same conditions, as summarized in FIG. 9. The camshaft rotation speed selected is 15 rpm. The angle of rotation selected for each blister volume tested is the maximum determined in the previous tests according to FIGS. 7-8. In the worst-case scenario, blisters with the highest available volume (200 μl) are used. The design of the impelling surface (2′) and/or the main surface (6) (the contact surface area between the pusher and the blister) is critical to avoid dispensing gas bubbles. With a suitable pusher design (as the preferred embodiment P02), it is possible to store all the air inside the blister body (1) when said blister is actuated.

When considering the total amount of liquid that can be extracted from the blister, P01 has the lowest efficiency. Furthermore, P03, P04 and P05 geometries exhibit a much larger amount of air volume injected in the microfluidic circuit via the fluidic output channel (4). In this way, the optimal pusher design corresponds to P02, with which it has been possible to increase 35 μl the average dispensed liquid volume in comparison with P01, and at the same time, to avoid relevant air injection.

The most significant difference between P02 and the other pushers under study (P03, P04 and P05) is having the maximum height (H) of the pusher closer to the fluidic outlet channel (4) (see FIGS. 3-4), thereby allowing to push the air and liquid in opposite directions. For validation purposes, the form of this pusher P02 has been designed with a constant angle (α). Nevertheless, this is only a particular embodiment of the invention, and more complex topologies are also valid, including multi angles or free-form pusher impelling surfaces (2′).

As a summary, to overcome the limitations of the prior-art dome-shaped pushers, this invention comprises a new header (2) (pusher) design. Particularly, the pusher geometry P02 is advantageous in terms of liquid (reagent) volume dispensed without gas bubbles. As displayed in FIG. 2, the pusher height must be maximum (H) on the side adjacent to the fluidic outlet channel (4) and minimum (h) on the opposite side. The notch prevents the fluidic outlet channel (4) from collapsing as the pusher crushes the blister body (1) and the liquid is flowing out towards a microfluidic circuit. The notch is advantageous for avoiding the collapse of the fluidic outlet channel (4) until most of the liquid volume stored within the blister has been released, as well as for minimizing the backflow of the fluid towards the blister body (1). In this way, the blister is not completely collapsed when the fluidic output channel (4) is occluded, thereby arranging a portion of the blister body (1) adapted to store the formed gas bubbles.

1-14. (canceled)

15. A blister opening system comprising:
a blister body arranged over a support surface, wherein said blister body is collapsible under pressure and adapted for storing a liquid volume;
a header comprising an impelling surface, wherein said header is adapted for being movable relative to the blister body and to transmit, with said relative movement, a pressure against the blister body through the impelling surface in a pushing direction;
a fluidic outlet channel fluidically connected to the blister body, and adapted such that the liquid volume can flow from the blister body towards said fluidic outlet channel when pressure is exerted against the blister body by the header;
the impelling surface of the header is arranged such that, in at least a relative position between the header and the blister body:
the pushing direction and the support surface form a relative angle substantially different from 90°;
the pressure of the impelling surface against the blister body configures a gas entrapment volume in the blister body, wherein said gas entrapment volume is arranged substantially at an opposite side of the blister body with regard to the fluidic outlet channel.

16. The blister opening system according to claim 1, wherein the impelling surface is adapted to press the blister body to dispense at least the 80% of the liquid volume stored within the blister body through the fluidic outlet channel.

17. The blister opening system according to claim 1, wherein the impelling surface of the header is substantially tilted relative to the support surface at the complementary angle of the relative angle.

18. The blister opening system according to claim 1, wherein the impelling surface of the header is substantially parallel to the support surface.

19. The blister opening system according to claim 1, wherein the blister body comprises a blister surface adapted to contact the impelling surface, said blister surface being substantially tilted relative to the support surface at the complementary angle of the relative angle.

20. The blister opening system according to claim 1, wherein the header comprises a plunger or a pusher.

21. The blister opening system according to claim 1, wherein the impelling surface of the header is substantially flat.

22. The blister opening system according to claim 1, wherein the impelling surface of the header comprises one or more indentations and/or recesses.

23. The blister opening system according to claim 1, wherein the header comprises a notch, a protrusion or an indentation placed adjacent to the fluidic outlet channel.

24. The blister opening system according to claim 1, wherein the impelling surface is adapted such that, in at least a position where the header exerts pressure on the blister body, said impelling surface occludes the fluidic outlet channel, while at least a portion of the blister body stores the gas volume within the gas entrapment volume.

25. The blister opening system according to claim 1, wherein the header is adapted to be switchable, at least, between two positions wherein, in a first position, the impelling surface occludes the fluidic outlet channel, and in a second position, the impelling surface leaves open the fluidic outlet channel.

26. The blister opening system according to claim 1, further comprising a holder adapted with at least a blister seat for placing a blister body, and actuation means comprising:
a mechanical arrangement, comprising a piston and a snail cam connected to a rotating camshaft; a stepper motor for actuating the rotating camshaft and, thereby, inducing a displacement of the piston; said piston transmitting pressure to the header depending on the direction, angle, and speed of camshaft rotation.

27. The blister opening system according to claim 1, further comprising a switch configured to stop the rotation of the mechanical arrangement in one of the following cases:
if the piston reaches a predetermined maximum shift or position;
if the header contact with the blister body.

28. The blister opening system according to claim 12, further comprising a blister metering device fluidically connected to the fluid outlet channel, said blister metering device being adapted to measure the liquid volume and the gas volume dispensed through the fluidic outlet channel.
